(19) United States
(12) Patent Application Publication
(10) Pub. No.: US 2004/0035853 A1
(43) Pub. Date: Feb. 26, 2004

(54) HEATING MAT

(76) Inventor: Aaron Pais, Mississauga (CA)

Correspondence Address: Aaron PAIS, c/o PROTECTIONS EQUINOX INT'L INC., Suite 224, 4480, Cote-de-Liesse, Montreal, QBC, H4N 2R1, CA

(21) Appl. No.: 10/227,300

(22) Filed: Aug. 26, 2002

(51) Int. Cl. H05B 3/28

(52) U.S. Cl. 219/548; 219/543; 219/213; 392/432

(57) ABSTRACT

A heating mat electrically connectable to a power source provided with a conductive prong connected to an electrical polarity defines a mat peripheral edge. The heating mat includes a conductor mounted therein and extending towards a connecting section located adjacent the mat peripheral edge. A resistive element electrically coupled to the conductor transforms the electrical energy into thermal energy. A connecting recess extends into the heating mat adjacent the connecting section and defines a prong receiving section to receive the conductive prong so that when the conductive prong is inserted into the prong receiving section the conductive prong is electrically coupled to the conductor. The prong receiving section defines a prong section base wall. A conductor spacer maintains the conductor in a predetermined spaced apart relationship relative to the prong section base wall so that the conductive prong is positioned between the conductor and the prong section base wall and electrically coupled to the conductor when inserted into the prong receiving section. The heating mat is also customizable in length.

### FIELD OF THE INVENTION

The present invention relates to the general field of cold weather accessories and is particularly concerned with a heating mat.

### BACKGROUND OF THE INVENTION

Many attempts have to be made over the years to provide a snow/ice melting surfaces in order to prevent any accumulation of snow or ice thereon. Some configurations promote permanent installation of the heating element underneath or inside the surface as described in U.S. Pat. No. 4,564,745 to Deschenes and U.S. Pat. No. 5,605,418 to Watanabe. However these permanent installations are usually expensive and require customized sizing up the heating elements.

To make the heating mat more affordable, several external-type configurations have been developed over the years, as exemplified, amongst many others, by U.S. Pat. Nos. 6,180,929 and 6,184,496 to Pearce; U.S. Pat. No. 6,172,344 to Gordon et al. and U.S. Pat. No. 6,194,692 to Oberly.

All these heating mats are generally customizable in length. However, the customization is generally performed during manufacturing of the heating mat since the cutting, electrical coupling, sealing of the edge of the heating mat require special tooling and/or ability and manual dexterity that only experienced people may have to perform such an operation. Accordingly these customized heating mats are generally more expensive than the one provided in specific standard length sizes.

The user/buyer of such a heating mat does not have the ability to customize the length of his heating mat on the spot unless he has (or buys) the required special tooling and/or the ability of performing such an operation.

There is therefore a need for a truly customizable heating mat that would require absolutely no special tooling or manual dexterity from the person customizing the heating mat.

### SUMMARY OF THE INVENTION

It is therefore a general object of the present invention to provide an improved heating mat.

An advantage of the present invention is that the heating mat is easily connectable to a power/terminating bracket and sealed therewith.

Another advantage of the present invention is that the heating mat is customizable in length without affecting its functioning.

Still another advantage of the present invention is that the heating mat is provided with anchoring or attaching features such as grommet-type through holes to secure the mat to its supporting surface.

Yet another advantage of the present invention is that the heating mat is provided with at least one connecting recess configured and sized for receiving at least a section of a conductive prong for electrical connection thereof and a conductive element spacer for maintaining a conductive element in a predetermined spaced apart relationship relative to the connecting recess so as to allow the conductive element to be electrically coupled to the conductive prong when the latter is inserted into the connecting recess.

A further advantage of the present invention is that the heating mat is provided with connecting recesses for all electrical connections such that the heating mat is entirely electrically connected by slidably connecting one of its ends with a corresponding connecting bracket that further seals off the end of the heating mat.

Still another advantage of the present invention is that the heating mat is provided with a textured pattern providing for a nonskid surface that allows for water drainage as well as for cutting references.

Yet a further advantage of the present invention is that the heating mat is easily assembled and electrically connected to a power/connecting/sealing bracket via a series of economic steps, without any tool and/or any special manual dexterity or ability from the operator.

Yet another advantage of the present invention is that the heating mat can be installed on any type of surface such as driveways, walkways, including stairs, roofs or the like or even inside walls, underneath floors, beneath driveways and/or walkway surfaces, etc.

According to an aspect of the present invention, there is provided a heating mat electrically connectable to a power source, the power source defining at least two electrical polarities and providing at least one conductive prong for one of the electrical polarities, the heating mat defining a mat peripheral edge, the heating mat comprises:

an electrically conductive element mounted at least partially within the heating mat, the conductive element extending towards a connecting section located generally adjacent the mat peripheral edge;

an electrically resistive element electrically coupled to the conductive element for transforming electrical energy from the power source into thermal energy;

a connecting recess extending into the heating mat adjacent the connecting section, the connecting recess defining a prong receiving section for receiving at least a section of the conductive prong so that when the conductive prong is inserted into the prong receiving section the conductive prong is electrically coupled to the conductive element, the prong receiving section defining a prong section base wall;

a conductive element spacer for maintaining the conductive element in a predetermined spaced apart relationship relative to the prong section base wall so that the conductive prong is positioned between the conductive element and the prong section base wall and electrically coupled to the conductive element when inserted into the prong receiving section.

Typically, the conductive element spacer includes a conductive element supporting section formed in the heating mat for supporting the conductive element in the predetermined spaced apart relationship relative to the prong section base wall.

Typically, the heating mat further includes a generally planar electrically insulating sheet, the insulating sheet defining generally opposed first and second sheet surfaces extending adjacent the connecting section, the first sheet surface being oriented towards the resistive element;

the connecting recess being formed within the insulating sheet adjacent the connecting position and extending inwardly from the first sheet surface, the prong receiving section having generally opposed first and second prong section lateral walls extending between the first sheet surface and the prong section base wall, the first and second prong section lateral walls having first and second lateral wall-to-first sheet surface intersection edges, respectively;

wherein the first and second lateral wall-to-first sheet surface intersection edges form the conductive element supporting section.

Typically, the first and second prong section lateral walls are oriented generally perpendicularly relative to the first sheet surface and define a prong section lateral wall distance therebetween;

the conductive element supporting section having generally opposed first and second conductive element section lateral walls extending inwardly and generally perpendicularly to the first sheet surface adjacent the first and second prong section lateral walls, respectively, the first and second conductive element section lateral walls defining a conductive element section lateral wall distance therebetween, the latter being larger that the prong section lateral wall distance;

the conductive element supporting section having a conductive element section base wall extending between first and second conductive element section lateral walls and the first and second prong section lateral walls, the conductive element section base wall being spaced apart from the prong section base wall so as to support the conductive element in the predetermined spaced apart relationship relative to the prong section base wall.

Preferably, the conductive element spacer is a filler component, the filler component at least partially filling the prong receiving section for supporting the conductive element in the predetermined spaced apart relationship relative to the prong section base wall, the filler component being deformable so as to allow passage of the section of the conductive prong upon the latter being inserted into the prong receiving section.

Preferably, the heating mat defines a mat longitudinal axis, the heating mat further comprises:

a generally planar electrically insulating sheet, the insulating sheet defining generally opposed first and second sheet surfaces extending towards the connecting section, the first sheet surface being oriented towards the resistive element;

the connecting recess being formed within the insulating sheet adjacent the connecting section and extending inwardly from the first sheet surface, the prong receiving section having generally opposed first and second prong section lateral walls extending between the first sheet surface and the prong section base wall;

wherein the first and second prong section lateral walls are sized to allow the prong receiving section to maintain the conductive element in the predetermined spaced apart relationship relative to the prong section base wall while being in electrically coupled to the prong when the latter is inserted into the prong receiving section.

Preferably, the mat peripheral edge includes first and second generally opposed mat side edges and first and second longitudinal mat end edges extending therebetween, the connecting section being adjacent the first mat end edge.

Preferably, the conductive element defines first and second generally opposed longitudinal conductive element ends, the first and second conductive element ends being adjacent the first and second mat end edges, respectively.

Preferably, the conductive element is a first conductive element, the resistive element defining first and second resistive element side edges located adjacent the first and second mat side edges, respectively; the heating mat including a second conductive element extending between the first and second mat end edges, the first and second conductive elements being generally adjacent the first and second mat side edges and being electrically coupled to the first and second resistive element side edges, respectively.

Preferably, the first and second conductive elements have a generally elongated planar shape, each of the conductive elements defines first and second generally opposed conductive element surfaces, the first conductive element surfaces being oriented towards the first sheet surface, the second conductive element surfaces being oriented towards the resistive element.

Typically, the heating mat further includes a third conductive element extending between the first and second mat end edges, the third conductive element being located between the first and second conductive elements with its first conductive element surface being oriented towards the first sheet surface and its second conductive element surface being oriented towards and electrically coupled to the resistive element.

Preferably, the connecting recess and the first and second prong section lateral walls extend between the first and second mat end edges.

Preferably, the electrically insulating sheet is a first electrically insulating sheet, the resistive element having a generally planar shape and defining first and second generally opposed resistive element surfaces, the heating mat further comprises:

a second generally planar electrically insulating sheet, the first sheet surface of each of the first and second insulating sheets being oriented towards a respective of the first and second resistive element surfaces, at least one of the second sheet surface of at least one of the first and second insulating sheets having a textured pattern imprinted thereon.

Preferably, the heating mat further includes a third generally planar electrically insulating sheet and a generally planar electrically conductive sheet, the third insulating sheet and conductive sheet generally extending between the first and second mat end edges and substantially extending between the first and second mat side edges, the third insulating sheet and conductive sheet being positioned between the resistive element and the second insulating sheet with the third insulating sheet electrically isolating the resistive element from the conductive sheet.

Preferably, the power source further defines a ground polarity and provides a ground conductive prong therefore, the conductive sheet extending towards a ground connecting section located generally adjacent the mat first end edge;

a ground connecting recess extending into the second insulating sheet adjacent the ground connecting section, the ground connecting recess defining a ground prong receiving section for receiving at least a section of the ground conductive prong so that when the ground conductive prong is inserted into the ground prong receiving section the ground conductive prong is electrically coupled to the conductive sheet, the ground prong receiving section defining a ground prong section base wall;

a conductive sheet spacer for maintaining the conductive sheet in a predetermined spaced apart relationship relative to the ground prong section base wall so that the ground conductive prong is positioned between the conductive sheet and the ground prong section base wall and electrically coupled to the conductive sheet when inserted into the ground prong receiving section.

Preferably, the heating mat further includes a plurality of through holes adjacent the mat peripheral edge, the through holes being spaced apart from each other along the mat peripheral edge, the through holes extending between second sheet surfaces of the first and second insulating sheets, whereby the through holes are used for securing the heating mat to an adjacent supporting surface.

Preferably, the plurality of through holes form at least one pair of through holes adjacent each of the first and second mat side edges, the at least one pair of through holes adjacent the first mat side edge being in register with a corresponding pair of through holes adjacent the second mat side edge so as to define a mat cutting area therebetween, the mat cutting area extending between the first and second mat side edges and between the through holes of each of the registered pairs of through holes.

Preferably, the heating mat further includes an edge tape, the edge tape extending from the second surface of the first insulating sheet to the second surface of the second insulating sheet first along first and second mat side edges and wrapping around the latter, heating mat further including grommet-type fasteners securing the edge tape to the heating mat adjacent the through holes, the through holes further extending through the edge tape.

Preferably, the power source defines first and second electrical polarities, the conductive prong being electrically coupled to the first electrical polarity, the first and second conductive elements being electrically coupled to the first electrical polarity, the third conductive element being electrically coupled to the second electrical polarity.

Preferably, the heating mat further includes at least one electrically conductive film, the conductive film being generally elongated and defining generally opposed first and second film surfaces, the first film surface facing the second conductive element surface of one of the first and second conductive elements and being electrically coupled therewith, the second film surface facing the resistive element and being electrically coupled therewith, the conductive film being deformable so as to ensure electrical coupling between the resistive element and the one of the first and second conductive elements.

According to another aspect of the present invention, there is provided in combination, a heating mat and a power bracket electrically connectable to a power source, the power source defining at least two electrical polarities, the heating mat electrically connecting to the power bracket, the power bracket defining a conductive prong extending towards a bracket connecting section, the conductive prong being electrically connectable to one of the electrical polarities, the heating mat defining a mat peripheral edge, the mat peripheral edge defining a mat connecting section, the heating mat comprises:

an electrically conductive element mounted at least partially within the heating mat, the conductive element extending towards a conductive element connecting section located generally adjacent the mat connecting section of the mat peripheral edge;

an electrically resistive element electrically coupled to the conductive element for transforming electrical energy from the power source into thermal energy;

a connecting recess extending into the heating mat adjacent the conductive element connecting section, the connecting recess defining a prong receiving section for receiving at least a section of the conductive prong so that when the bracket connecting section is connected to the mat connecting section the conductive prong is inserted into the prong receiving section and the conductive prong is electrically coupled to the conductive element, the prong receiving section defining a prong section base wall;

a conductive element spacer for maintaining the conductive element in a predetermined spaced apart relationship relative to the prong section base wall so that the conductive prong is positioned between the conductive element and the prong section base wall and electrically coupled to the conductive element when inserted into the prong receiving section.

Preferably, the conductive element is a first conductive element, the resistive element defining first and second resistive element side edges located adjacent the first and second mat side edges, respectively; the heating mat including a second conductive element extending between the first and second mat end edges, the first and second conductive elements being generally adjacent the first and second mat side edges and being electrically coupled to the first and second resistive element side edges, respectively;

wherein the conductive prong is a first conductive prong, the power bracket defining a second conductive prong being electrically connectable to another one of the electrical polarities, the first and second conductive prongs electrically coupling to the first and second conductive elements, respectively, upon insertion of the first and second conductive prongs into the prong receiving section of corresponding of the connecting recesses when the bracket connecting section is connected to the mat connecting section.

Preferably, the bracket connecting section includes a mat receiving recess extending into the power bracket for receiving at least a section of the first mat end edge so that when the first mat end edge is inserted into the mat receiving recess with the mat connecting section connected to the bracket connecting section the first and second conductive prongs are inserted into the prong receiving section of corresponding of the connecting recesses and the first and second conductive prongs are electrically coupled to the first and second conductive elements, respectively.

Preferably, the power bracket has a generally planar shape, the power bracket defining a bracket peripheral edge and generally opposed first and second bracket surfaces, the bracket connecting section extending along the bracket peripheral edge, the bracket connecting section including a bracket lid adjacent the mat receiving recess, the bracket lid being hingedly openable between an open configuration and a closed configuration, the bracket lid allowing insertion of the mat connecting section into the mat receiving recess when in the open configuration and securing the mat connecting section into the mat receiving recess with the first and second conductive prongs electrically coupled to the first and second conductive elements, respectively, when in the closed configuration.

Preferably, the bracket connecting section includes a locking means for releasably locking the bracket lid into the closed configuration with the first and second conductive prongs electrically coupled to the first and second conductive elements, respectively, the locking means including a hook component mounted on the bracket lid for locking engagement with a complementary hook receiving component when the bracket lid is in the closed configuration.

Preferably, the bracket connecting section includes a mat retaining means for retaining the mat connecting section connected to the bracket connecting section so that the heating mat is secured to the power bracket when the bracket lid is in the closed configuration with the mat connecting section connected to the bracket connecting section.

Preferably, the electrically insulating sheet is a first electrically insulating sheet, the resistive element having a generally planar shape and defining first and second generally opposed resistive element surfaces, the heating mat further comprising:

a second generally planar electrically insulating sheet, the first sheet surface of each of the first and second insulating sheets being oriented towards a respective of the first and second resistive element surfaces;

the heating mat defining at least one through hole adjacent the mat connecting section, the through hole extending between second sheet surfaces of the first and second insulating sheets, the power bracket defining a protrusion stud adjacent the bracket connecting section, the protrusion stud extending outwardly from the power bracket into the mat receiving recess, the protrusion stud being located, configured and sized to fittingly engage the through hole when the mat connecting section is connected to the bracket connecting section, the protrusion stud and the through hole forming the mat retaining means when in fitting engagement with each other.

Preferably, the resistive element includes a plurality of electrically resistive sub-elements being electrically connected in parallel relative to each other.

Preferably, each of the resistive sub-elements defines first and second generally opposed sub-element ends, each of the sub-element ends being electrically connected to a respective of the first and second conductive elements, the plurality of resistive sub-elements being generally equally spaced apart from each other so as to define predetermined non-heat generating regions between adjacent of the resistive sub-elements.

Preferably, the heating mat includes a plurality of apertures extending therethrough between the second sheet surfaces of the first and second insulating sheets, the apertures being located between adjacent of the resistive sub-elements;

at least one of the apertures being adjacent the mat connecting section, the power bracket defining an aperture stud adjacent the bracket connecting section, the protrusion stud extending outwardly from the power bracket into the mat receiving recess, the aperture stud being located, configured and sized to fittingly engage the at least one of the apertures when the mat connecting section is connected to the bracket connecting section, the aperture stud and the at least one of the apertures further forming the mat retaining means when in fitting engagement with each other.

Preferably, the power bracket is generally elongated and defines generally opposed first and second bracket ends, the bracket connecting section generally extending between the first and second bracket ends,

the power bracket including a power cord, the power cord defining generally axially opposed first and second cord ends, the first cord end being electrically coupled to the first and second conductive prongs, the second cord end being electrically connectable to the power source.

Preferably, the combination further includes a terminating bracket, the terminating bracket defining a terminating bracket peripheral edge and a mat receiving section adjacent the terminating bracket peripheral edge, the mat receiving section defining a mat receiving recess extending into the terminating bracket from the terminating bracket peripheral edge, the mat receiving recess being configured and sized to receive the second mat end edge therein so as to sealably secure the second mat end edge.

Preferably, the electrically insulating sheet is a first electrically insulating sheet, the resistive element having a generally planar shape and defining first and second generally opposed resistive element surfaces, the heating mat further comprising:

a second generally planar electrically insulating sheet, the first sheet surface of each of the first and second insulating sheets being oriented towards a respective of the first and second resistive element surfaces, at least one of the second sheet surface of at least one of the first and second insulating sheets insulating sheet having a textured pattern imprinted thereon.

Preferably, the power source further defines a ground polarity, the power bracket defining a ground conductive prong extending towards the bracket connecting section, the ground conductive prong being electrically connectable to the ground polarity, the conductive sheet extending towards a ground connecting section located generally adjacent the mat first end edge;

a ground connecting recess extending into the second insulating sheet adjacent the ground connecting section, the ground connecting recess defining a ground prong receiving section for receiving at least a section of the ground conductive prong so that when the bracket connecting section is connected to the mat connecting section the ground conductive prong is inserted into the ground prong receiving section and the ground conductive prong is electrically coupled to the conductive sheet, the ground prong receiving section defining a ground prong section base wall;

a conductive sheet spacer for maintaining the conductive sheet in a predetermined spaced apart relationship relative to the ground prong section base wall so that the ground conductive prong is positioned between the conductive sheet and the ground prong section base wall and electrically coupled to the conductive sheet when inserted into the ground prong receiving section.

Other objects and advantages of the present invention will become apparent from a careful reading of the detailed description provided herein, within appropriate reference to the accompanying drawings.

### BRIEF DESCRIPTION OF THE DRAWINGS

Embodiments of the present invention will now be disclosed by way of examples, in reference to the following drawings in which like reference characters indicate like elements throughout.

FIG. 1, in a partially broken and exploded perspective view, illustrates a heating mat in accordance with an embodiment of the present invention;

FIG. 2, in a broken enlarged section view taken along line 2-2 of FIG. 1, illustrates the electrical coupling between a conductive element and the corresponding conductive prong;

FIG. 3, in a broken enlarged section view taken along line 3-3 of FIG. 1, illustrates the electrical coupling between the conductive sheet and the corresponding ground conductive prong;

FIG. 4, in a broken enlarged section view taken along line 4-4 of FIG. 1, illustrates the position of the different layers of the heating mat around a side edge thereof;

FIG. 5, in a broken enlarged section view taken along line 5-5 of FIG. 1, illustrates the mat retaining means of the power bracket for retaining the mat end edge into its bracket connecting section;

FIG. 6, in an exploded broken enlarged section view taken along line 6 of FIG. 1, illustrates the insertion of the conductive prong into the corresponding prong receiving section of the connecting recess;

FIG. 7, in an enlarged partially broken top perspective view, illustrates the power bracket with its lid in closed configuration;

FIG. 8, in a view similar to FIG. 7, illustrates the power bracket with its lid in open configuration;

FIG. 9, in a partially broken bottom perspective view, illustrates the bottom surfaces of the power bracket and the heating mat;

FIG. 10, in a broken enlarged section view taken along line 10-10 of FIG. 7, illustrates the power bracket locking means for releasably locking the lid in the closed configuration;

FIG. 11, in view similar to FIG. 6, illustrates another embodiment of the conductive element spacer used to maintain the conductive element in a predetermined spaced apart relationship relative to the corresponding prong section base wall;

FIG. 12, in a broken enlarged perspective view, illustrates another embodiment of the textured pattern of the top surface of the heating mat and of the resistive element;

FIG. 13, in a broken enlarged perspective view, illustrates another heater arrangement of the heating mat with three conductive elements;

FIGS. 14 and 15, in views similar to FIG. 13, illustrate two heater arrangements with two and three conductive elements respectively, mounted side-by-side within a same heating mat and electrically connected in parallel to each other;

FIG. 16, in a broken enlarged perspective view, illustrates another embodiment of the heating mat in accordance with the present invention;

FIG. 17, in a broken enlarged section view taken along line 17-17 of FIG. 16, illustrates the details of the through apertures of the embodiment of FIG. 16;

FIG. 18, in their view similar to FIG. 8, illustrates the details of the power bracket used in conjunction with the embodiment of FIG. 16;

FIG. 19, in a partially broken top perspective view, illustrates another embodiment of the present invention being used on the driveway; and

FIG. 20, in a view similar to FIG. 19, illustrates other embodiments of the present invention being used on a walkway, a stairway and on the edge of a roof.

### DETAILED DESCRIPTION OF THE PREFERRED EMBODIMENTS

With reference to the annexed drawings the preferred embodiments of the present invention will be herein described for indicative purpose and by no means as of limitation.

As a general consideration, it should be noted that the figures do not necessarily show the exact proportion of the dimension of the different components illustrated therein. Some dimensions may have been voluntarily exaggerated for clarity purposes only.

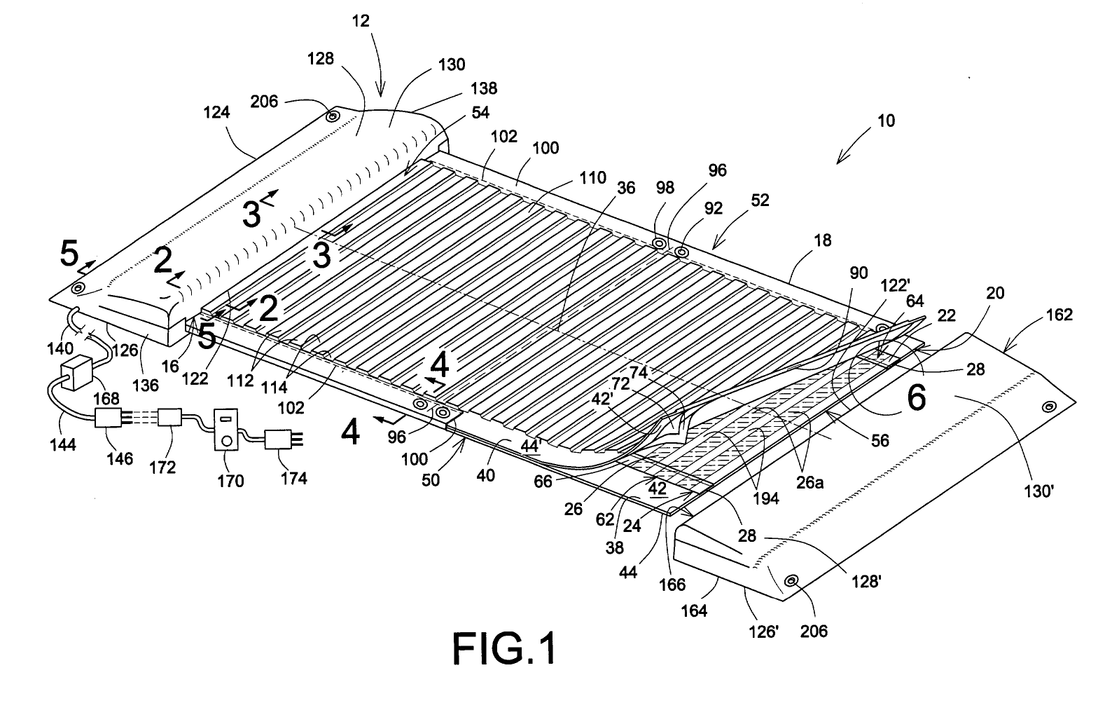

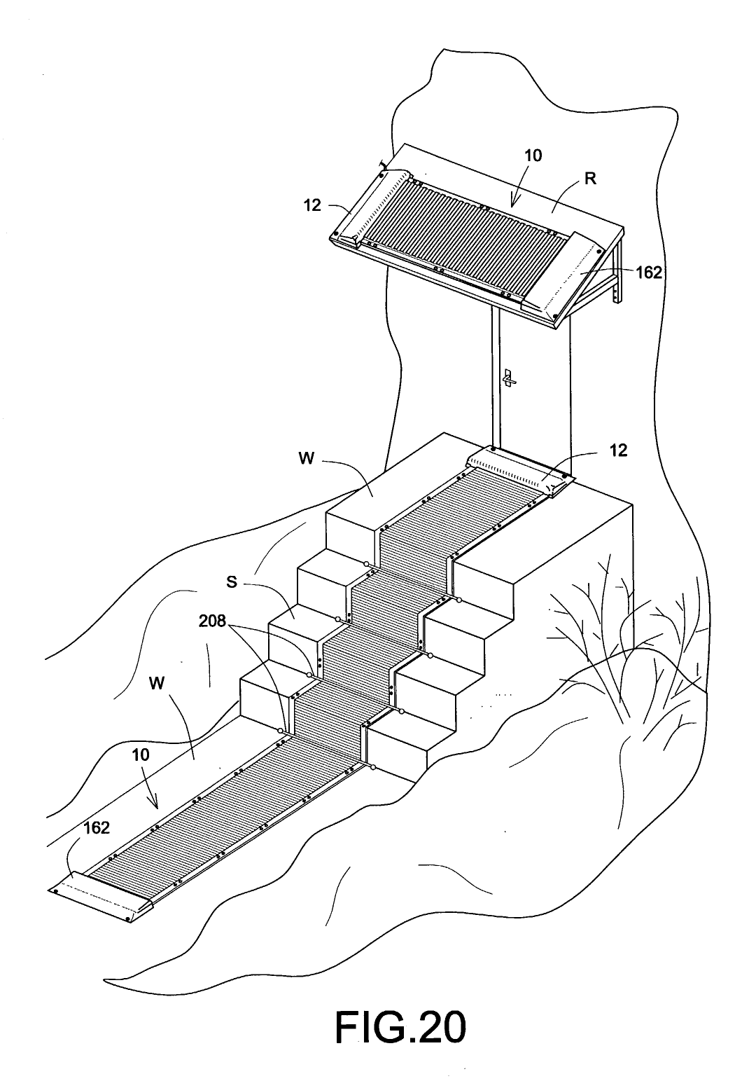

Referring to FIG. 1, there is shown a heating mat 10 in accordance with an embodiment of the present invention typically for melting snow or ice accumulating thereon. As shown more specifically in FIGS. 19 and 20, the heating mat 10 of the present invention is preferably used on driveways D, walkways W, stairs S and roof edges R. Although not specifically shown herein, the heating mat 10 of the present invention could also be used for heating large areas, in applications such as floor heating, wall heating and also be placed under area rugs or the like without departing from the scope of the present invention.

The heating mat 10 preferably electrically connects to a power bracket 12, the latter being electrically connectable to a power source (not shown) such as electric power available from any conventional AC outlet (not shown) of a household or the like.

The power bracket 12 defines the conductive prong 14, or jack, being electrically connectable to an electrical polarity of the power source and extending towards a bracket connecting section 16. The power bracket 12 is further detailed hereinafter.

The heating mat 10 is generally planar and defines a mat peripheral edge 18. The mat peripheral edge 18 defines a mat connecting section 20. An electrically conductive element 22, more conventionally called a bus bar or a conductor, mounted at least partially within the heating mat 10 extends towards a conductive element connecting section 24 located generally adjacent the mat connecting section 20 of the mat peripheral edge 18.

An electrically resistive element 26, more conventionally called a heating or heat dissipating element, electrically coupled with a conductive element 22 to transform the electrical energy supplied by the power source into thermal energy. A connecting recess 28 extends into the heating mat 10 adjacent the conductive element connecting section 24. The connecting recess 28 defines prong receiving section 30, or receptacle, to receive, preferably slidably, at least a section of the conductive prong 14 so that when the bracket connecting section 16 is connected to the mat connecting section 20 the conductive prong 14 is inserted into the prong receiving section 30 and a conductive prong 14 is electrically coupled to the conductive element 22. The prong receiving section 30 defines a prong section base wall 32.

A conductive element spacer 34, preferably made out of a filler component 35, maintains the conductive element 22 in a predetermined spaced apart relationship relative to the prong section base wall 32 so that the conductive prong 14 is positioned between the conductive element 22 and a prong section base wall 32 and electrically coupled to the conductive element 22 when inserted into the prong receiving section 30. The filler component 35 at least partially fills the prong receiving section 30 to support the conductive element 22 in the predetermined spaced apart relationship relative to the prong section base wall 32. The filler component 35 is deformable so as to allow passage of the conductive prong 14 upon the latter being inserted into the prong receiving section 30.

As more specifically illustrated in FIGS. 1 through 6, the heating mat 10 generally defines a mat longitudinal axis 36. Typically, two generally opposed first and second planar electrically insulating sheets 38, 40 form the outermost layers of the heating mat 10. Each insulating sheet 38, 40 defines generally opposed first 42, 42′ and second 44, 44′ sheet surfaces extending towards the conductive element connecting section 24, respectively. The first sheet surface 42, 42′ is generally oriented towards the resistive element 26. The connecting recess 28 is formed within the first insulating sheet 38, preferably the bottom sheet, adjacent the conductive element connecting section 24 and extends inwardly from the first sheet surface 42. The prong receiving section 30 has generally opposed first and second prong section lateral walls 46, 48 that expand between the first sheet surface 42 and a prong section base wall 32. The first and second prong section lateral walls 46, 48 are sized to allow the prong receiving section 30 to maintain the conductive element 22 in the predetermined spaced apart relationship relative to the prong section base wall 32 while being in electrically coupled to the conductive prong 14 when the latter is inserted into the prong receiving section 30.

Preferably, the mat peripheral edge 18 includes the first and second generally opposed mat side edges 50, 52 substantially parallel to the mat longitudinal axis 36 and first and second longitudinal mat end edges 54, 56 extending there between. The conductive element connecting section 24 is adjacent the first mat end edge 54. Also, the conductive element 22, being a first conductive element 22, defines generally opposed first and second longitudinal conductive element ends 58, 60 that are adjacent the first and second mat end edges 54, 56, respectively.

The resistive element 26 being also generally an elongated flexible planar sheet defines first and second resistive element side edges 62, 64 located adjacent the first and second mat side edges 50, 52, respectively. The heating mat 10 preferably includes a second conductive element 66 extending between the first and second mat end edges 54, 56. The first and second conductive element 22, 66 are generally adjacent the first and second mat side edges 50, 52 and are electrically coupled to the first and second resistive element side edges 62, 64, respectively.

Each conductive element 22, 66 has a generally elongated planar shape and defines first and second generally opposed conductive element surfaces 68, 70 with the first conductive element surface 68 been oriented towards the first sheet surface 42 of the first insulating sheet 38 and the second conductive element surface semi been oriented towards the resistive element 26.

In order to more uniformly spread the heat generated by the resistive element 26 throughout the entire heating mat 10 and to provide an electrical grounding protection against potential perforations of the heating mat 10, a generally planar electrically conductive sheet 72 substantially covering the entire heating mat 10 is preferably included within the heating mat 10 between the second insulating sheet 40 and a third insulating sheet 74. The latter electrically isolates the conductive sheet 72 from the resistive element 26 and the first and second conductive elements 22, 66.

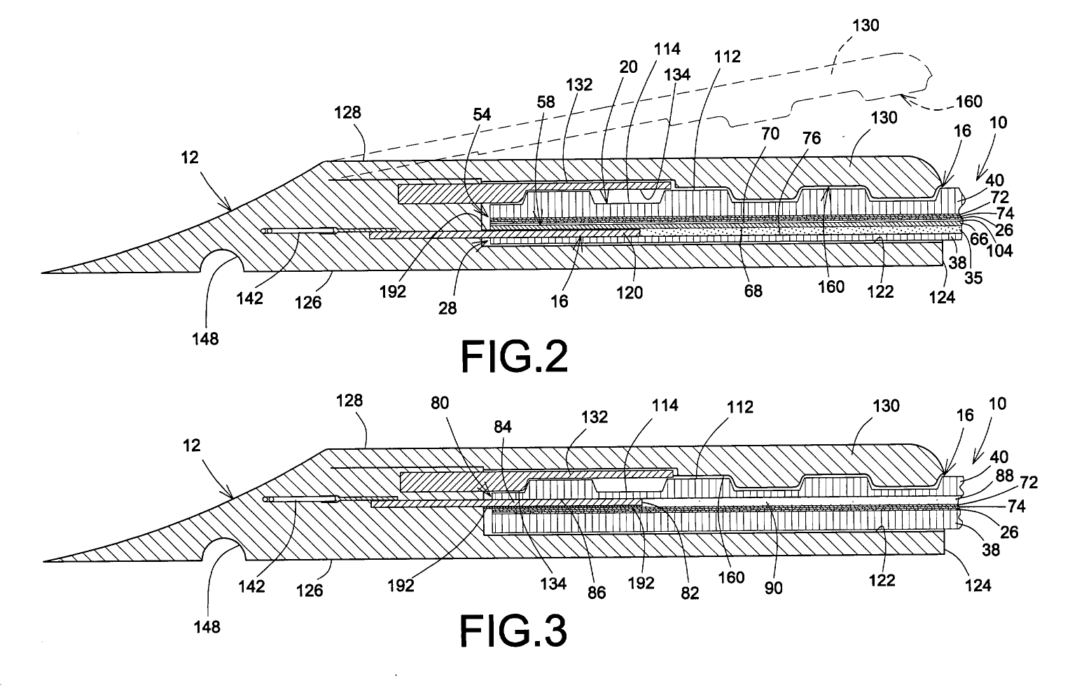

As illustrated more specifically in FIG. 2, the prong section base wall 32 and the first and second prong section lateral walls 46, 48 of each connecting recess 28 preferably extend between the first and second mat 10 edges 54, 56 so that each connecting recess 28 forms a longitudinal conductive element groove or channel 76 adjacent a corresponding conductive element 22, 66.

Accordingly, the filler component 35, preferably a foam type material or the like, fills the entire conductive element groove 76. Although it is preferred that the filler component 35 entirely fills the conductive element groove 76, it could also partially fill the groove 76 either longitudinally between the first and second mat end edges 54, 56 or transversely between the first and second prong section lateral walls 46, 48 without departing from the scope of the present invention, as long as the conductive element 22, 66 is maintained in the predetermined spaced apart relationship relative to the prong section base wall 32.

Similarly, the conductive sheet 72 extends towards the ground connecting section 78 located generally adjacent the mat first end edge 54. A ground connecting recess 80 extends into the second insulating sheet 40 adjacent the ground connecting section 78. The ground connecting recess 80 defines a ground prong receiving section 82 for receiving at least a section of a ground conductive prong 84 of the power bracket 12 so that when the ground conductive prong 84 is inserted into the ground prong receiving section 82 the ground conductive prong 84 is electrically coupled to the conductive sheet 72. Also, the ground prong receiving section 82 defines a ground prong section base wall 86. A conductive sheet spacer 88 for maintaining the conductive sheet 72 in a predetermined spaced apart relationship relative to the ground prong section base wall 86 so that the ground conductive prong 84 is positioned between the conductive sheet 72 and a ground prong section base wall 86 and electrically coupled to the conductive sheet 72 when inserted into the ground prong receiving section 82.

Preferably, as illustrated in FIGS. 1 and 3, the ground connecting recess 80 forms a longitudinal ground groove or channel 90 extending inwardly into the second insulating sheet 40 from its first sheet surface 42′. Also, the ground channel 90 preferably extends between the first and second mat end edges 54, 56 adjacent the conductive sheet 72. The conductive sheet spacer 88 is a ground filler component, preferably made out of a foam type material or the like at least partially filling the ground groove 90, to support the conductive sheet 72 in the predetermined spaced apart relationship relative to the ground prong section base wall 86. The ground filler component 88 is deformable so as to allow passage of the ground conductive prong 84 upon the latter being inserted into the ground prong receiving section 82. The conductive sheet 72 is typically made out of aluminum or any alloy thereof.

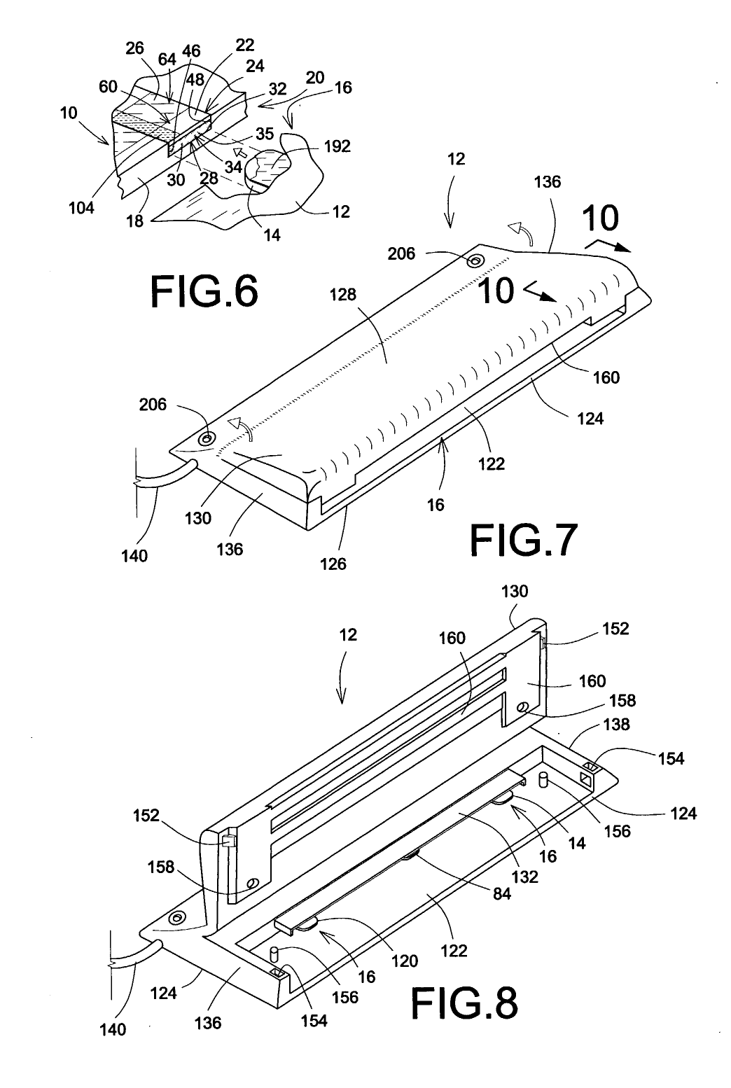

As illustrated more specifically in FIG. 6, the conductive element 22 is configured and sized so that it is entirely supported in the predetermined spaced apart relationship relative to the prong section base wall 32 by the filler component 35 with its upper surface being substantially in register with or slightly protruding above the first surface 42 of the first insulating sheet 38. In other words, the conductive element 22 has a width generally equal or smaller than the distance between the first and second prong section lateral walls 54, 56.

The conductive elements 22, 66 are preferably made out of, but not limited to, any one or any combination of the following materials: copper or other electrically conductive metal foil, strip or woven wire braid, moulded conductive plastics conductors. Conductive plastics or silicone elastomers may be used as cements for the conductive elements 22,66 which may also be sewn onto the resistive element 26. The conductive elements 22, 66 may be electrically conductive coated to reduce any possible oxidation and other forms of corrosion.

The resistive element 26 is preferably made out of, but not limited to, any one or any combination of the following materials: carbon loaded plastic material such as Kapton XC™ or the like, carbon filled material, carbon loaded and/or filled coating material, paint, ink or the like, arrangement of discrete resistors, carbonized fabric material, carbon black filled materials and carbon-based conductive textiles.

As illustrated more specifically in FIGS. 1, 4 and 5, the heating mat 10 further includes a plurality of through holes 92 adjacent the mat peripheral edge 18. The through holes 92 used to secure the heating mat 10 to an adjacent supporting surface such as the driveway D or the like using screws or anchors (not shown) or the like securing components, are spaced apart from each other and generally extend between the second sheet surfaces 44, 44′ of the first and second insulating sheets 38, 40.

The through holes 92 are preferably located within a mat attaching section 94 of the heating mat 10. The mat attaching section 94 is generally defined to be between each of the first and second mat side edges 50, 52 and a corresponding of the first and second resistive element side edges 62, 64. The mat attaching section 94 generally corresponds to a section of the heating mat 10 in which the first and second insulating sheets 38, 40 directly face each other.

At least one pair of through holes 92 is located adjacent each one of the first and second mat side edges 50, 52. The two pairs being generally in register with each other so as to define a mat cutting area 96 there between, as shown by a long dash line in FIG. 1. The mat cutting area 96 extends between the first and second mat side edges 50, 52 and between the two through holes 92 of each pair in a direction generally perpendicular to the mat longitudinal axis 36 so that when the heating mat 10 is cut along the mat cutting area 96 to modify its overall length of the newly generated mat end edges each include a pair of through holes 92 there along. Typically, the different pairs of through holes 92 located along a same mat side edge 50, 52 are generally equally spaced apart from each other so that the heating mat 10 could be customized in length at predetermined locations. Preferably each pair of through holes 92 is spaced apart from the adjacent pair by a distance varying approximately between one foot and three feet.

Typically, the through holes 92 are punched through the heating mat 10 using a specific punching tool (not shown) that simultaneously secures a grommet-type fastener 98 or the like around the periphery of the through holes 92 so as to protect the periphery and better secure the two insulating sheets 38, 40 together. Preferably, to improve the sealing between the two insulating sheets 38, 40, an edge tape 100 extends from the second surface 44 of the first insulating sheet 38 to the second surface 44′ of the second insulating sheet 40 along each other first and second mat side edges 50, 52 by wrapping around the latter.

The edge tape 100 is preferably installed on the heating mat 10 prior to the punching of the through holes 92 such that it is simultaneously punched with the first and second insulating sheets 38, 40 and secured thereto via the grommet-type fastener 98. The edge tape 100 is preferably made out of a non-abrasive, water and mildew resistant material such as Nylon™, cotton, polyester web material, combinations thereof, or the like and may be provided with a color stripe pattern (not shown) or the like to visually identify the side edges 50, 52 of the heating mat 10.

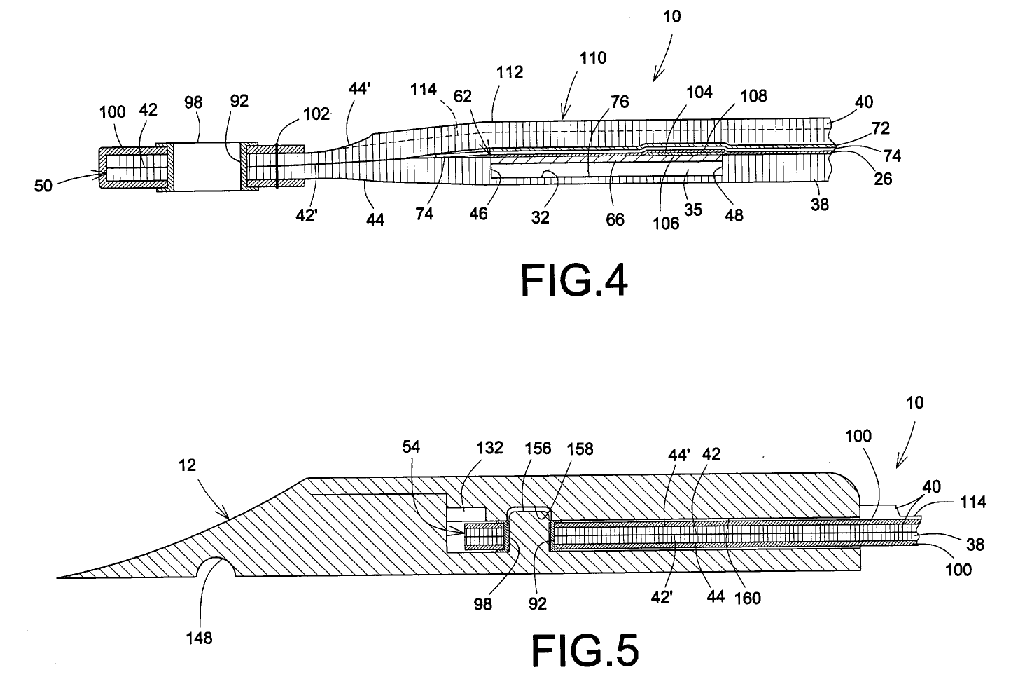

Although the grommet-type fasteners 98 are used to secure the edge tape 100 to the heating mat 10, the edge tape 100 is preferably either adhesively bonded to the heating mat 10 or simply sewn thereto with a sewing line 102 running along the corresponding mat side edge 50, 52 and through the heating mat 10, as illustrated by the dotted lines in FIG. 1 and by a dark line in FIG. 4.

An electrically conductive film 104 is used to improve the electrical coupling between each one of the first and second conductive elements 22, 66 and the resistive element 26. The conductive film 104 is generally elongated, deformable and flexible. and defines generally opposed first and second film surfaces 106, 108. The first film surface 106 faces the second conductive element surface 70 of one of the conductive elements 22, 66 and is electrically coupled therewith. The second film surface 108 faces the resistive element 26 and is electrically coupled therewith. The conductive film 104 is deformable so as to ensure a good electrical coupling between the resistive element 26 and one of the first and second conductive elements 22, 66.

As shown in FIG. 4, the conductive film 104 generally extends over a longitudinal portion of the conductive element 22, 66, preferably an inner portion thereof oriented towards the other conductive element 66, 22. Preferably, the conductive film 104 is an electrically conductive adhesive such as a double-sided tape, a silver-loaded paste, or any other highly electrically conductive deformable thin material, ink, paint or the like. The conductive film 104 could also take the form of an electrically conductive hot air adhesive coat or plastic melt tape that may be sewn over the resistive element 26. This helps to keep the conductive elements 22, 66 in place and reduces electrical breakdown under stress and the possibility of corrosion. Although not shown in the figures, the conductive elements 22, 66 could include a plurality of longitudinally spaced apart through perforations to improve the electrical coupling with the corresponding conductive prong 14, 84, the conductive film 104 and/or the resistive element 26.

Based on the application that the heating mat 10 is used for, the insulating sheets 38, 40, 74 are preferably made out of, but not limited to, any one or any combination of the following materials: any polymeric type material including thermoset rubbers such as natural rubber, butyl rubber, nitrile rubber, silicone rubber and the like, vulcanized polymeric material, thermoplastic elastomers including oledinics, urethanes, vinyl, polyethylene, polyester, Kapton™ and the like laminate materials. Especially for snow melting applications, the protective first and second insulating sheets 38, 40 are preferable made out of a non-abrasive material reinforced by fibrous or woven material, such as cotton, nylon, polyester, fiberglass, polymeric fibers, or similar fiber materials, embedded therein, or similar materials that can be woven within the base material.

In order for the heating mat 10 to substantially form a single component, the first and second insulation sheets 38, 40, the resistive element 26, the conductive sheet 72 and the third insulating sheet 74 which comprise the different layers of the heating mat 10 are preferably adhesively attached to their adjacent layers either by using typical double-sided adhesives, thermal fusion bonding, electrochemical bonding, glue, caulk, ultrasonic welding, lamination, burying or any other conventional method/material known in the art. This is done to prevent any sliding between layers and to sealably protect any electrical component from the environment that the heating mat 10 is used in.

Preferably, the resistive element 26 and the conductive elements 22, 66 are at least partially buried into the third insulating sheet 74, whenever applicable depending on the type of material used for the different components.

As illustrated in FIG. 1, the second surface 44′ of the second insulating sheet 40, or top external surface of the heating mat 10, preferably includes a textured pattern 110 imprinted thereon. The textured pattern 110 is generally used to enhance the grip effect of the surface 44′ to prevent slippage of any body (not shown) being temporarily supported thereon as well as to form drainage channels for the rain water or the water obtained from snow or ice melting to be drained away from the heating mat 10 along with other undesirable particulates such as sand or the like, whenever applicable.

More specifically, the textured pattern 110 represented in FIGS. 1 through 5, is oriented in a direction generally perpendicular to the mat longitudinal axis 36 and is formed of a plurality of generally elongated rectangular bosses 112 or ribs separated from each other by generally trapezoidal cross-section grooves 114, valleys or channels therebetween. Preferably, the textured pattern 110 does not extend into the mat attaching section 94 with the bosses 112 tapering down or rounding off adjacent the mat side edges 50, 52 to provide a substantially flat surface region of the mat attaching section 94 that is eventually covered with the edge tape 100. Obviously, the textured pattern 110 could eventually fully extend between first and second mat side edges 50, 52.

Although the textured pattern 110 described hereinabove is substantially linear in shape, any other geometry of textured pattern such as Chevron or V-shaped lines or the like or any other general orientation of the pattern could be used without departing from the scope of the present invention.

As more clearly illustrated in FIG. 1, each pair of through holes 92 with their grommet-type fasteners is so located and oriented such that both through holes 92 are generally in register with two successive bosses 112. Accordingly, the heating mat 10 could be cut along the groove 114 between the two successive bosses 112.

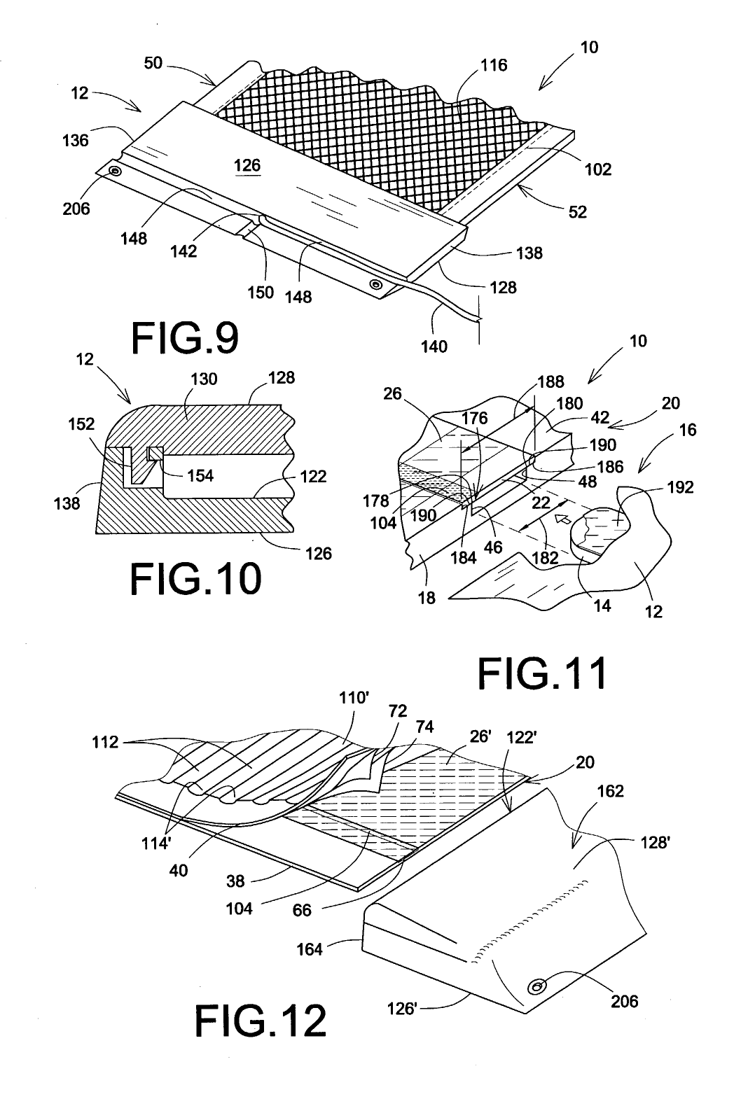

In order to improve the adherence of the heating mat 10 onto its supporting surface such as the driveway D or the like, the second surface 44 of the first insulating sheet 38, or bottom external surface of the heating mat 10, preferably includes a different and smaller textured pattern 116 imprinted thereon, as illustrated in FIG. 9. Although a diamond shaped textured pattern 116 is depicted in FIG. 9, any other type of textured pattern 116 could be used without departing from scope of the present invention.

Referring more specifically to FIGS. 1 through 3 and 5 through 10, the power bracket 12 defines the first and second conductive prongs 14, 120 that are electrically connectable to be conventional two electrical polarities of any power source. The first and second conductive prongs 14, 120 extend towards the bracket connecting section 16 and electrically couple to the first and second conductive elements 22, 66, respectively upon insertion of the first and second conductive prongs 14, 120 into the prong receiving section 30 of the corresponding connecting recess 28 when the bracket connecting section 16 is connected to the mat connecting section 20.

Preferably, the bracket connecting section 16 includes a mat receiving recess 122 extending into the power bracket 12 to receive at least a section of the first mat end edge 54 so that when the first mat end edge 54 is inserted into the mat receiving recess 122 with the mat connecting section 20 connected to the bracket connecting section 16 the first and second conductive prongs 14, 120 are inserted into the prong receiving section 30 of the corresponding connecting recess 28 in the first and second conductive prongs 14, 120 are electrically coupled to the first and second conductive elements 22, 66, respectively.

The power bracket 12 has a generally planar shape and defines the bracket peripheral edge 124 and generally opposed first and second bracket surfaces 126, 128. The bracket connecting section 16 extends along the bracket peripheral edge 124 and includes a bracket lid 130, or flap, adjacent the mat receiving recess 122. The bracket lid 130 is hingedly openable between an open configuration, shown in FIG. 8 and in dotted lines in FIG. 2, and a closed configuration, shown in FIGS. 1 through 7. The bracket lid 130 allows insertion of the mat connecting section 20 into the mat receiving recess 122 when in the open configuration and secures the mat connecting section 20 into the mat receiving recess 122 with the first and second conductive prongs 14, 120 electrically coupled to the first and second conductive elements 22, 66, respectively, when in the closed configuration. The hinge is preferably provided by the flexibility of the deformable material the power bracket 12 is made out of.

In order to properly align the mat connecting section 20, or the first mat end edge 54, with the first and second conductive prongs 14, 120 and the ground conductive prong 84 of the bracket connecting section 16, a generally elongated guiding plate 132 protrudes out from the power bracket 12 into the mat receiving recess 122 generally above the conductive prongs 14, 84, 120 to guide the first mat end edge 54 their below. The guiding plate 132 also acts as a protective plate for the conductive prongs 14, 84, 120 and prevents any damage that could be caused to the latter.

As illustrated more specifically in FIGS. 2 and 3, the surface 134 of the guiding plate 132 facing the conductive prongs 14, 84, 120 is preferably so shaped as to generally assume the shape of the textured pattern 110 adjacent the first mat end edge 54.

The power bracket 12 is generally elongated and defines generally opposed first and second bracket ends 136, 138 with the bracket connecting section 16 generally extending therebetween. The power bracket 12 includes a conventional power cord 140 defining generally axially opposed first and second cord ends 142, 144. The first cord end 142 is electrically coupled to the conductive prongs 14, 84, 120 inside the power bracket 12 while the second cord end 144 is electrically connectable to the power source via a conventional AC (alternating current) jack connector 146 or the like; obviously, the connector 146 could be a DC (direct current) connector without departing from the scope of the present invention. Obviously different wires connectable to the two conventional positive and negative electrical polarities and to the ground polarity of the power source are connected to the different conductive prongs 14, 120, 84, respectively.

Preferably, as illustrated in FIG. 9, the power bracket 12 further includes a cord channel 148 extending into the power bracket 12 from the first bracket surface 126. The cord channel 148 extends between the first and second bracket ends 136, 138 so that the power cord 148 at least partially longitudinally engages the cord channel 148 to extend from either end 136, 138 between the first and second bracket surfaces 126, 128. Furthermore, a short transversal channel 150 also extending into the power bracket 12 from the first bracket surface 126 have a position intermediate the first and second bracket ends 136, 138, preferably halfway in between. The transversal channel 150 allows the power cord 148 to extend from the power bracket 12 in the direction of the mat longitudinal axis 36.

Alternatively, the power cord 140 can also directly come out of either end 136, 138 of the power bracket 12.

Preferably, the bracket connecting section 16 of the power bracket 12 includes a locking means for releasably locking the bracket lid 130 into the closed configuration with the conductive prongs 14, 84, 120 electrically coupled to the conductive elements 22, 66 and to the conductive sheet 72. The locking. means includes a hook component 152 mounted on the bracket lid 130 for locking engagement with a complementary hook receiving component 154 when the bracket lid 130 is in the closed configuration, as shown in FIGS. 8 and 10.

The locking means is preferably designed so as it is generally easy to open the bracket lid 130 when no heating mat 10 is inserted into the mat receiving recess 122 while it is practically impossible to do the same once the mat connecting section 20 is connected to the bracket connecting section 16.

Furthermore, the bracket connecting section 16 includes a mat retaining means for retaining the mat connecting section 20 connected to the bracket connecting section 16 so that the heating mat and is secured to the power bracket 12 when the bracket lid 130 is in the closed configuration with the mat connecting section 20 connected to the bracket connecting section 16.

Consequently, the power bracket 12 defines at least one protrusion stud 156 adjacent the bracket connecting section 16. The protrusion stud 156 extends outwardly from the power bracket 12 into the mat receiving recess 122. The protrusion stud 156 is located, configured and sized to fittingly engage a corresponding through hole 92 when the mat connecting section 20 is connected to the bracket connecting section 16. The protrusion stud 156 and the corresponding through hole 92 form the mat retaining means when in fitting engagement with each other, as shown in FIG. 5. Obviously any other type of retaining means could be considered without departing from the scope of the present invention.

Preferably, the protrusion stud 156 is generally longer than the depth of the through hole 92, or the thickness of the heating mat 10 along the mat site edges 50, 52. Accordingly, the bracket lid 130 includes a stud recess 158 for receiving the portion of the protrusion stud 156 protruding out of the through hole 92 so that the heating mat 10 is better retained into the mat receiving recess 122 of the power bracket 12. The stud recess 158 extends inwardly into the bracket lid 130 from an internal surface 160 thereof.

As shown in FIGS. 2, 3 and 8, the internal surface 160 of the power bracket 12 is generally shaped so that it assumes the portion of the textured pattern 110 engaging the mat receiving recess 122. The internal surface 160 is generally a mirror profile of the textured pattern 110 so that the bracket lid 130 helps to retain the heating mat 10 secured to the power bracket 12 while allowing for a water sealed interface therebetween. How deep the mat connecting section 20 gets into the connecting recess 28 of the bracket connecting section 16 can vary depending on the application the heating mat 10 is used for.

Depending on the application that it is used for, the power bracket 12 could be of different design, such as a tile shape (not shown) with a bracket connection section that could snap on the adjacent heating mat, without departing from the scope of the present invention.

Alternatively, for snow melting applications, the power bracket 12 could also have a variety of designs. The distance between the first and second bracket ends 136, 138 could be equal or slightly greater than the width of the heating mat 10, or the distance between the first and second mat side edges 50, 52. Accordingly, the hook components 152 of the locking means could be built into a removable bracket lid or the like component that would snap into the power bracket 12 and through the grommet-type through holes 92 of the mat side edges 50, 52. Also, the locking means could be of an interlocking-type design, such that the complementary hook and hook receiving components 152, 154 on the removable bracket lid 130 and on the power bracket 12 respectively, bite into each other to lock the power bracket 12 to the heating mat 10.

The power bracket 12 is generally connected to the heating mat 10 to provide electrical power thereto and is attached to the first mat end edge 54 to preferably sealably close off the latter. Similarly, a terminating bracket 162 is attached to the second mat end edge 56 to also preferably sealably close off the latter.

The terminating bracket 162 defines a terminating bracket peripheral edge 164 and a mat receiving section 166 adjacent the terminating bracket peripheral edge 164. The mat receiving section 166 defines a mat receiving recess 122′ extending into the terminating bracket 162 from the terminating bracket peripheral edge 164. The mat receiving recess 122′ is substantially configured and sized to receive the second mat end edge 56 therein.

The terminating bracket 162 defines generally opposed first and second terminating bracket surfaces 126′, 128′. The mat receiving section 166 extends along the terminating bracket peripheral edge 164 and includes the bracket lid 130′ adjacent the mat receiving recess 122′ similarly to the power bracket 12.

The mat receiving section 166 includes a locking means similar to the power bracket locking means for releasably locking the bracket lid 130′ into its closed configuration with the second mat end edge 56 being inserted into the mat receiving section 166. Also, the mat receiving section 166 includes a mat retaining means similar to the power bracket retaining means for retaining the second mat end edge 56 inserted into the mat receiving section 166 so that the heating mat 10 is secured to the terminating bracket 162 when the bracket lid 130′ is in its closed configuration. Essentially, the difference between the terminating bracket 162 and the power bracket 12 is that the terminating bracket 162 does not include any conductive prongs or the like since no electrical connections are really required at the second mat end edge 56.

The method of connecting the heating mat 10 to the power bracket 12 and the terminating bracket 162 is relatively simple and is performed through a series of ergonomical steps without any specific tool. Furthermore, no specific ability or manual dexterity is required. First, the heating mat 10 is customized in length by cutting the latter through a mat cutting area 96. Then the hook component 152 of the locking means is released from its corresponding hook receiving component 154 to open the corresponding bracket lid 130, 130′. Then each end edge 54, 56 of the heating mat 10 is slidably inserted into the corresponding mat receiving recess 122, 122′ under the guiding plate 132 to properly coupled the different conductive prongs 14, 84, 120 to either their respective conductive element 22, 66 (and 196 when applicable) or conductive sheet 72, and to properly engage the protrusion studs 156 into the respective through holes 92 adjacent the respective mat end edge 54, 56.

The bracket lid 130, 130′ is then locked back in closed configuration while ensuring that the heating mat 10 is properly sealed off to the bracket 12, 162. Sealing compound such as silicone, tar-like sealant/adhesive or the like can be used at all interfaces between the heating mat 10 and the bracket peripheral edge 124, 164 to improve the watertight seal therebetween.

As shown in FIG. 1, the power cord 140 preferably includes a conventional ground fault circuit interrupter (GFCI) 168, an equipment leakage circuit interrupter (ELCI) or the like, as appropriate, which is electrically connected in series with the resistive element 26. Optionally, a conventional timer controller 170 could also be connected in series with the resistive element 26 of the heating mat 10 to automatically control the powering of the latter. The timer controller 170 preferably includes a built-in AC (or DC) receptacle connector 172 and AC (or DC) jack connector 174 or the like for electrical connection with the AC (or DC) connector 146 of the power cord 140 and the conventional AC (or DC) outlet of the power source, respectively.

Furthermore, the timer controller 192 and/or the heating mat 10 with the power bracket 12 directly could be remotely activated (not shown), through different mechanisms such as, using a remote control or through the Internet. As an energy saver, a thermal cutout switch, and/or a humidity sensor switch (not shown) could be used in series with the timer control 192 and/or the power bracket 12 cut the power off when no heating is required. Obviously, as it is well known in the art, such sensors could either be integral with the heating mat 10 or the power bracket 12 or be standalone devices.

Alternatively, as illustrated in FIG. 11, the conductive element spacer 34 includes a conductive element supporting section 176 formed in the heating mat 10 to support the conductive element 22 in the predetermined spaced apart relationship connected to the prong section base wall 32.

Preferably, the first and second prong section lateral walls 46, 48 have first and second lateral wall-to-first sheet surface intersection edges 178, 180, respectively. The latter are adapted for supporting the conductive element 22 thereon so as to form the conductive element supporting section 176, such as in the case in which the conductive element 22 is wider than the conductive element groove 76.

Preferably, the first and second prong section lateral walls 46, 48 are oriented generally perpendicularly relative to the first sheet surface 42 of the first insulating sheet 38 and define the prong section lateral wall distance 182 therebetween. The conductive element supporting section 176 has generally opposed first and second conductive element section lateral walls 184, 186 extending inwardly and generally perpendicularly to the first sheet surface 42 adjacent the first and second prong section lateral walls 46, 48, respectively. The first and second conductive element section lateral walls 184, 186 define a conductive element section lateral wall distance 188 therebetween, the latter being larger than the prong section lateral wall distance 182.

The conductive element supporting section 176 has a conductive element section base wall 190 that extends between the first and second conductive element section lateral walls 184, 186 and the first and second prong section lateral walls 46, 48, respectively. The conductive element section base wall 190 being spaced apart from the prong section base wall 32 so as to support the conductive element 22 in the predetermined spaced apart relationship relative to the prong section base wall 32. The conductive element section base wall 190 substantially replaces the filler component 35 to support the conductive element 22.

Also, as shown in FIGS. 6 and 11, the conductive prong 14 has its surface facing the conductive element 22, when inserted in to the prong receiving section 30, preferably covered with an electrically conductive paste, coating, adhesive tape 192 or the like so as to ensure a good electrical coupling therebetween as well as to prevent tarnishing of the surfaces in contact, reduce arcing, radio-frequency interferences (RFI) and intermittent electrical connections at the contacting region. The conductive paste 192 substantially melts once the first power application occurs to improve the electrical coupling and then solidifies to ensure good electrical coupling for the rest of the life of the heating mat 10. As illustrated in FIGS. 2 and 3, the conductive paste 192 is preferably used on all conductive prongs 14, 120 and ground conductive prong 84.

As illustrated in FIG. 1, the resistive element 26 preferably includes a plurality of electrically resistive sub-elements 26a being electrically connected in parallel relative to each other. Each resistive sub-element 26 defines first and second generally opposed sub-element ends 62a, 64a. Each sub-element end 62a, 64a is electrically connected to a respective conductive element 66, 22. The resistive sub-elements 26a are generally elongated and equally spaced apart from each other so as defined predetermined non-heat generating regions 194 therebetween.

Alternatively, as illustrated in FIG. 12, the resistive element 26′ substantially entirely covers the surface area between the two conductive elements 22, 66 so as to provide a uniform heat dissipation over the heating mat 10. Also, the alternate textured pattern 110′ represented in FIG. 12 has a plurality of similar rectangular bosses 112 than the embodiment of FIG. 1 separated from each other by generally grooves 114′ or valleys having a generally semi-elliptical cross-sectional shape.

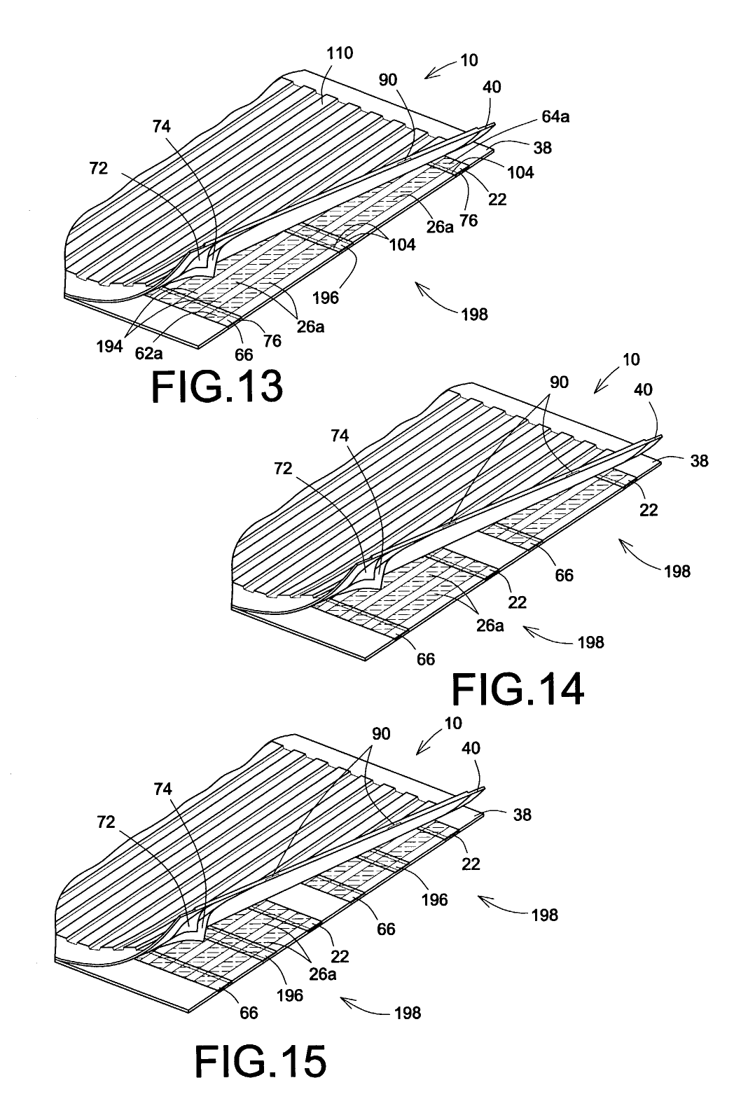

As shown in FIG. 13, the heating mat 10 includes the third conductive element 196 similar to the first and second conductive elements 22, 66 and generally parallel thereto. The third conductive element 196 is located intermediate the first and second conductive elements 22, 66, preferably substantially halfway therebetween. In such a configuration, the first and second conductive elements 22, 66 are both electrically coupled to a first electrical polarity of the power source via their respective conductive prongs 14, 120 and, the third conductive element 196 is electrically coupled to a second electrical polarity of the power source via a corresponding conductive prong (not shown) of the power bracket 12. Preferably, a conductive film 104 runs on each side of the third conductive element 196 to improve the electrical coupling between the latter and the resistive element 56.

Typically, the resistive element 26 and the first and second conductive elements 22, 66 of the heating mat 10, along with the third conductive element 196 whenever applicable, form a first heater 198 thereof. As shown in FIGS. 14 and 15, the heating mat 10 further includes at least a second heater 198 similar to the first one with the heaters 198, with two and three conductive elements respectively, being electrically connected in parallel relative to each other. Preferably, the heaters 198 are spaced apart from each other and extend in directions generally parallel to each other.

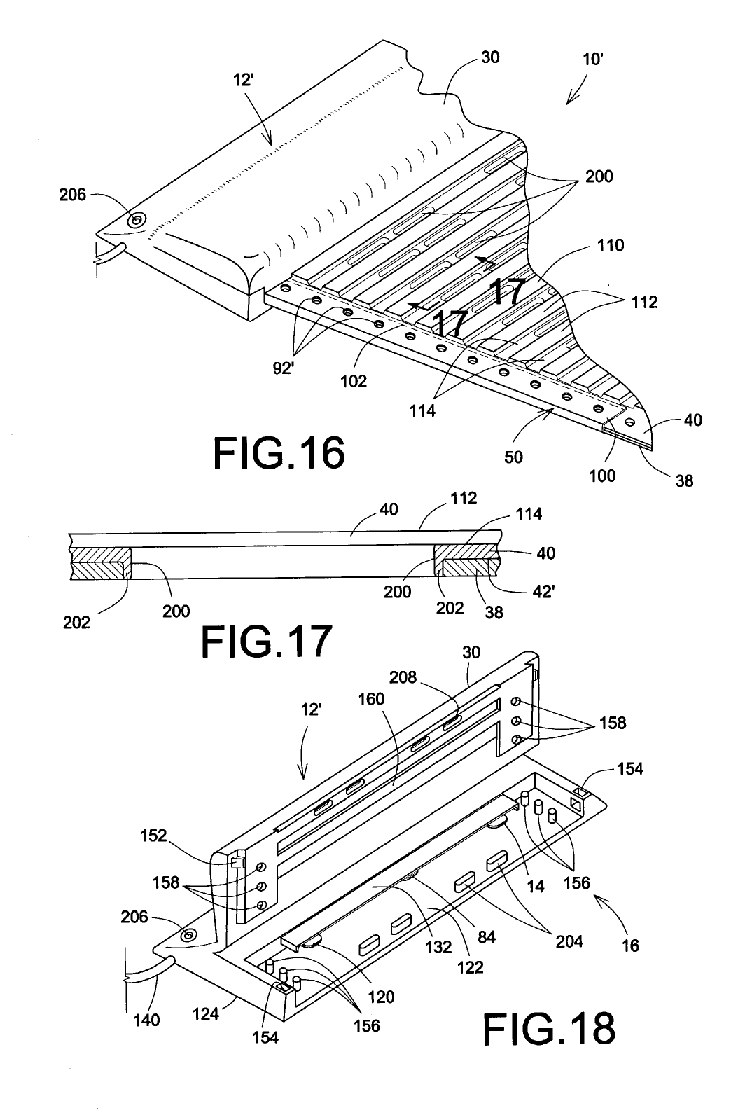

Referring more specifically to FIG. 16, there is shown another embodiment of the heating mat 10′ having a plurality of through holes 92′ generally equally spaced apart along the first and second mat side edges 50, 52. Preferably, there is a through hole 92′ in register with each rectangular bosses 112 of the textured pattern 110 such that the heating mat 10′ could be customized in length by cutting the latter between any adjacent bosses 112 without affecting the proper functioning of the heating mat 10′.

Furthermore, the heating mat 10′ includes a plurality of apertures 200 extending therethrough between the second sheet surfaces 44, 44′ of the first and second insulating sheets 38, 40. The apertures 200, preferably elongated in shape such as slots or the like, are generally located along each rectangular grooves 114 of the textured pattern 110. Accordingly, the apertures 200 preferably extend through the non-heat generating regions 194 of the heating mat 10, between the resistive sub-elements 26a. The apertures 200 are preferably provided to reduce the overall weight of the heating mat 10 in order to ease manipulation thereof.

In order to improve the sealing of the interface between the first and second insulating sheets 38, 40 at the periphery of the apertures 200, the second insulating sheet 40 preferably includes aperture peripheral lips 202 protruding outwardly from the first sheet surface 42′ towards the first insulating sheet 38 to substantially abut the periphery of the corresponding aperture 202 thereof, as illustrated in FIG. 17. Preferably, either epoxy, silicone or cement based sealing material or the like are used around the periphery of the apertures 200 to help the aperture peripheral lips 202 to seal off any local opening between the first and second insulating sheets 38, 40. This type of mat 10′ has a look similar to temporary barrier fencing with the regions between the apertures 202 in the longitudinal direction, raised to form the ribs 112 of the mat 10′.

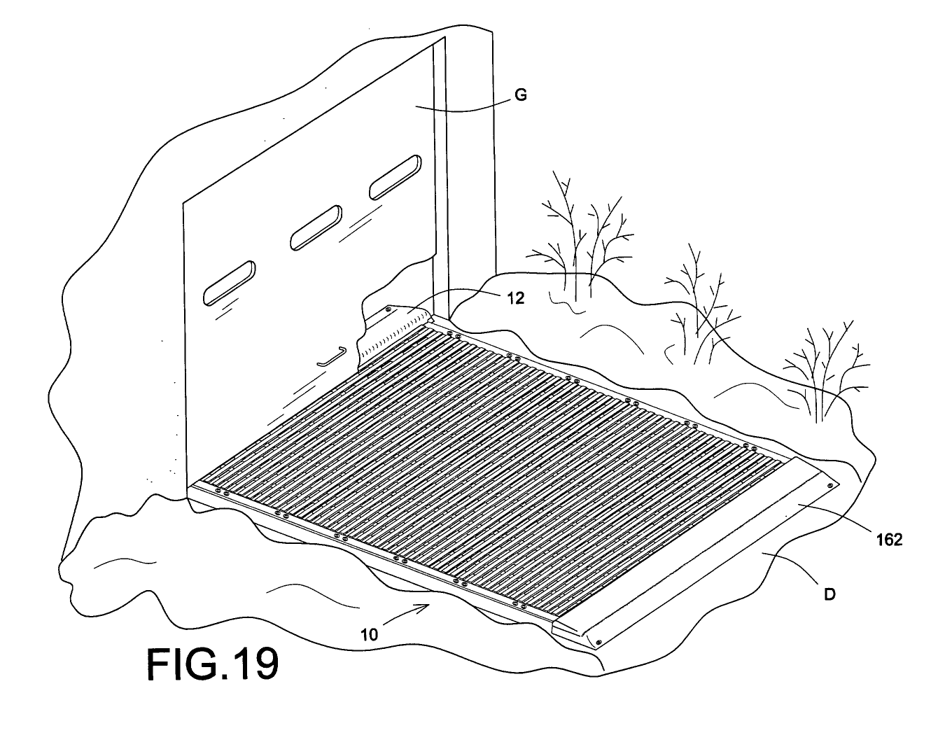

Accordingly, as shown in FIG. 18, the power bracket 12′ defines aperture studs 204 adjacent the bracket connecting section 16. The aperture studs 204 extend outwardly from the power bracket 12′ into the bracket receiving recess 122 and is located, configured and sized to fittingly engage corresponding apertures 200 when the mat connecting section 20 is connected to the bracket connecting section 16. The aperture studs 204 in the corresponding apertures 200 further form the mat retaining means when in fitting engagement with each other. Also, the bracket lid internal surface 160 preferably includes aperture stud recesses 208 to fittingly receive the free end of the aperture studs 204 therein, similarly to the stud recesses 158.

Optionally, the power bracket 12′ may further include additional protrusion studs 156 and corresponding stud recesses 158. Each protrusion stud 156 fittingly engages a corresponding through hole 92′ of the heating mat 10′.

As illustrated in FIGS. 1, 7, 19 and 20, the power bracket 12 and the terminating bracket 162 are preferably provided with through holes 206 and grommet-type fasteners to allow securing of the bracket 12, 162 to the supporting surface, similarly to the heating mat 10.

As specifically shown in FIG. 19, the heating mat 10 installed on the driveway D is preferably designed to extend under a garage door G when the latter is closed, with the power bracket 12 always remaining inside the garage; thereby providing for a longer life generation of the power bracket 12.

As shown in FIG. 20, the portion of heating mat 10 running on the stairs S is preferably secured thereto using stair rods 208 preferably running along trapezoidal grooves 114 of the textured pattern 110.

Although not shown, the heating mat 10 used on the roof edge R does not really require any non-skid pattern 110 thereon and could alternatively have its top second insulating sheet 40 made out of conventional roofing material such as shingles or the like. The walkway mats have been so designed, such that, it is relatively easy to convert them to roof mats with a flat top surface 44′, by adhesively attaching a cover (not shown) on top of the walkway mat 10, using adhesives or the like (not necessarily over the entire surface). The cover has a flat top surface and its bottom surface is a mirror profile of the top surface 44′ of the walkway mat 10 (may or may not cover the mat side edges 50, 52 and/or the edge tape 100), similarly than the inner surface 160 of the bracket lid 130. This enables the cover to fit snugly onto the top surface 44′ of the walkway mat 10. The cover is preferably made out of any conventional roofing material.

Obviously, the different embodiments described hereinabove preferably refer to a flexible heating mat 10 that could easily be removed and temporarily stored for long periods when it is not needed, such as in warm seasons. Furthermore, the power/terminating brackets 12, 162, although thicker than the heating mat 10 itself, remains relatively thin to allow any vehicle including bicycles, wheelchairs, strollers and the like to easily pass or roll thereover without any difficulty and/or possibly the of tilting over. Furthermore, as shown throughout the figures, the power bracket 12 and the terminating bracket 162 preferably have a top surface 128, 128′ with rounded edges and generally tapering or sloping down in a direction away from the heating mat 10 so as to allow any vehicle or the like to smoothly get on and off the mat 10 and its brackets 12, 162.

Although not illustrated herein, whenever required, the heating mat 10 of the present invention could be used upside-down with the conductive sheet 72 closer to the supporting surface than the resistive sheet 26 without departing from the scope of the present invention.

Although not specifically shown herein, for embedded type heating/warming applications, such as inside the floor, the wall or the like, the second surfaces 44, 44′ of both the first and second insulating sheets 38, 40 are preferably left generally flat (non-textured), without departing from the scope of the present invention.

Although the present heating mat has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A heating mat electrically connectable to a power source, said power source defining at least two electrical polarities and providing at least one conductive prong for one of said electrical polarities, said heating mat defining a mat peripheral edge, said heating mat comprising:
an electrically conductive element mounted at least partially within said heating mat, said conductive element extending towards a connecting section located generally adjacent said mat peripheral edge;
an electrically resistive element electrically coupled to said conductive element for transforming electrical energy from said power source into thermal energy;
a connecting recess extending into said heating mat adjacent said connecting section, said connecting recess defining a prong receiving section for receiving at least a section of said conductive prong so that when said conductive prong is inserted into said prong receiving section said conductive prong is electrically coupled to said conductive element, said prong receiving section defining a prong section base wall;
a conductive element spacer for maintaining said conductive element in a predetermined spaced apart relationship relative to said prong section base wall so that said conductive prong is positioned between said conductive element and said prong section base wall and electrically coupled to said conductive element when inserted into said prong receiving section.

2. The heating mat of claim 1 wherein said conductive element spacer includes a conductive element supporting section formed in said heating mat for supporting said conductive element in said predetermined spaced apart relationship relative to said prong section base wall.

3. The heating mat of claim 2 wherein said heating mat further includes a generally planar electrically insulating sheet, said insulating sheet defining generally opposed first and second sheet surfaces extending adjacent said connecting section, said first sheet surface being oriented towards said resistive element;
said connecting recess being formed within said insulating sheet adjacent said connecting position and extending inwardly from said first sheet surface, said prong receiving section having generally opposed first and second prong section lateral walls extending between said first sheet surface and said prong section base wall, said first and second prong section lateral walls having first and second lateral wall-to-first sheet surface intersection edges, respectively;
wherein said first and second lateral wall-to-first sheet surface intersection edges form said conductive element supporting section.

4. The heating mat of claim 3 wherein said first and second prong section lateral walls are oriented generally perpendicularly relative to said first sheet surface and define a prong section lateral wall distance therebetween;
said conductive element supporting section having generally opposed first and second conductive element section lateral walls extending inwardly and generally perpendicularly to said first sheet surface adjacent said first and second prong section lateral walls, respectively, said first and second conductive element section lateral walls defining a conductive element section lateral wall distance therebetween, the latter being larger that said prong section lateral wall distance;
said conductive element supporting section having a conductive element section base wall extending between first and second conductive element section lateral walls and said first and second prong section lateral walls, said conductive element section base wall being spaced apart from said prong section base wall so as to support said conductive element in said predetermined spaced apart relationship relative to said prong section base wall.

5. The heating mat of claim 1 wherein said conductive element spacer is a filler component, said filler component at least partially filling said prong receiving section for supporting said conductive element in said predetermined spaced apart relationship relative to said prong section base wall, said filler component being deformable so as to allow passage of said section of said conductive prong upon the latter being inserted into said prong receiving section.

6. The heating mat of claim 5 wherein said heating mat defines a mat longitudinal axis, said heating mat further comprising:
a generally planar electrically insulating sheet, said insulating sheet defining generally opposed first and second sheet surfaces extending towards said connecting section, said first sheet surface being oriented towards said resistive element;
said connecting recess being formed within said insulating sheet adjacent said connecting section and extending inwardly from said first sheet surface, said prong receiving section having generally opposed first and second prong section lateral walls extending between said first sheet surface and said prong section base wall;
wherein said first and second prong section lateral walls are sized to allow said prong receiving section to maintain said conductive element in said predetermined spaced apart relationship relative to said prong section base wall while being in electrically coupled to said prong when the latter is inserted into said prong receiving section.

7. The heating mat of claim 6 wherein said mat peripheral edge includes first and second generally opposed mat side edges and first and second longitudinal mat end edges extending therebetween, said connecting section being adjacent said first mat end edge.

8. The heating mat of claim 7 wherein said conductive element defines first and second generally opposed longitudinal conductive element ends, said first and second conductive element ends being adjacent said first and second mat end edges, respectively.

9. The heating mat of claim 8 wherein said conductive element is a first conductive element, said resistive element defining first and second resistive element side edges located adjacent said first and second mat side edges, respectively; said heating mat including a second conductive element extending between said first and second mat end edges, said first and second conductive elements being generally adjacent said first and second mat side edges and being electrically coupled to said first and second resistive element side edges, respectively.

10. The heating mat of claim 9 wherein said first and second conductive elements have a generally elongated planar shape, each of said conductive elements defines first and second generally opposed conductive element surfaces, said first conductive element surfaces being oriented towards said first sheet surface, said second conductive element surfaces being oriented towards said resistive element.

11. The heating mat of claim 10 further including a third conductive element extending between said first and second mat end edges, said third conductive element being located between said first and second conductive elements with its first conductive element surface being oriented towards said first sheet surface and its second conductive element surface being oriented towards and electrically coupled to said resistive element.

12. The heating mat of claim 10 wherein said connecting recess and said first and second prong section lateral walls extend between said first and second mat end edges.

13. The heating mat of claim 12 wherein said filler component at least partially fills said connecting recess between said first and second prong section lateral walls for supporting said first and second conductive elements in said predetermined spaced apart relationship relative to said prong section base walls.

14. The heating mat of claim 10 wherein said electrically insulating sheet is a first electrically insulating sheet, said resistive element having a generally planar shape and defining first and second generally opposed resistive element surfaces, said heating mat further comprising:
a second generally planar electrically insulating sheet, said first sheet surface of each of said first and second insulating sheets being oriented towards a respective of said first and second resistive element surfaces, at least one of said second sheet surface of at least one of said first and second insulating sheets having a textured pattern imprinted thereon.

15. The heating mat of claim 14 further including a third generally planar electrically insulating sheet and a generally planar electrically conductive sheet, said third insulating sheet and conductive sheet generally extending between said first and second mat end edges and substantially extending between said first and second mat side edges, said third insulating sheet and conductive sheet being positioned between said resistive element and said second insulating sheet with said third insulating sheet electrically isolating said resistive element from said conductive sheet.

16. The heating mat of claim 15 wherein said power source further defines a ground polarity and provides a ground conductive prong therefore, said conductive sheet extending towards a ground connecting section located generally adjacent said mat first end edge;
a ground connecting recess extending into said second insulating sheet adjacent said ground connecting section, said ground connecting recess defining a ground prong receiving section for receiving at least a section of said ground conductive prong so that when said ground conductive prong is inserted into said ground prong receiving section said ground conductive prong is electrically coupled to said conductive sheet, said ground prong receiving section defining a ground prong section base wall;
a conductive sheet spacer for maintaining said conductive sheet in a predetermined spaced apart relationship relative to said ground prong section base wall so that said ground conductive prong is positioned between said conductive sheet and said ground prong section base wall and electrically coupled to said conductive sheet when inserted into said ground prong receiving section.

17. The heating mat of claim 9 wherein said resistive element is composed of one of a carbon loaded plastic sheet, a carbon filled plastic sheet, carbon loaded fabric material, carbon loaded coating material, carbon filled coating material, conductive paint, conductive ink, carbonized fabric material and carbon-based conductive textile.

18. The heating mat of claim 14 further including a plurality of through holes adjacent said mat peripheral edge, said through holes being spaced apart from each other along said mat peripheral edge, said through holes extending between second sheet surfaces of said first and second insulating sheets, whereby said through holes are used for securing said heating mat to an adjacent supporting surface.

19. The heating mat of claim 18 defining a mat attaching section for attaching said mat to said adjacent supporting surface, said mat attaching section being located between each of said first and second mat side edges and corresponding of said first and second resistive element side edges, said mat attaching section receiving said through holes therein.

20. The heating mat of claim 19 wherein said plurality of through holes form at least one pair of through holes adjacent each of said first and second mat side edges, said at least one pair of through holes adjacent said first mat side edge being in register with a corresponding pair of through holes adjacent said second mat side edge so as to define a mat cutting area therebetween, said mat cutting area extending between said first and second mat side edges and between said through holes of each of said registered pairs of through holes.

21. The heating mat of claim 20 further including an edge tape, said edge tape extending from said second surface of said first insulating sheet to said second surface of said second insulating sheet first along first and second mat side edges and wrapping around the latter, heating mat further including grommet-type fasteners securing said edge tape to said heating mat adjacent said through holes, said through holes further extending through said edge tape.

22. The heating mat of claim 11 wherein said power source defines first and second electrical polarities, said conductive prong being electrically coupled to said first electrical polarity, said first and second conductive elements being electrically coupled to said first electrical polarity, said third conductive element being electrically coupled to said second electrical polarity.

23. The heating mat of claim 10 further including at least one electrically conductive film, said conductive film being generally elongated and defining generally opposed first and second film surfaces, said first film surface facing said second conductive element surface of one of said first and second conductive elements and being electrically coupled therewith, said second film surface facing said resistive element and being electrically coupled therewith, said conductive film being deformable so as to ensure electrical coupling between said resistive element and said one of said first and second conductive elements.

24. The heating mat of claim 23 wherein said electrically conductive film is an electrically conductive adhesive so as to adhesively attached to said first and second conductive elements and to said resistive elements while allowing electrical coupling therebetween.

25. The heating mat of claim 16 wherein each of said first, second and third insulating sheets, said resistive element and said ground conductive sheet forms a heating mat layer, each of said layers being adhesively attached to adjacent of said layers.

26. The heating mat of claim 9 wherein said resistive element and said first and second conductive elements form a first heater, said heating mat further including at least a second heater, said first and at least a second heaters being electrically connected in parallel relative to each other.

27. In combination, a heating mat and a power bracket electrically connectable to a power source, said power source defining at least two electrical polarities, said heating mat electrically connecting to said power bracket, said power bracket defining a conductive prong extending towards a bracket connecting section, said conductive prong being electrically connectable to one of said electrical polarities, said heating mat defining a mat peripheral edge, said mat peripheral edge defining a mat connecting section, said heating mat comprising:
an electrically conductive element mounted at least partially within said heating mat, said conductive element extending towards a conductive element connecting section located generally adjacent said mat connecting section of said mat peripheral edge;
an electrically resistive element electrically coupled to said conductive element for transforming electrical energy from said power source into thermal energy;
a connecting recess extending into said heating mat adjacent said conductive element connecting section, said connecting recess defining a prong receiving section for receiving at least a section of said conductive prong so that when said bracket connecting section is connected to said mat connecting section said conductive prong is inserted into said prong receiving section and said conductive prong is electrically coupled to said conductive element, said prong receiving section defining a prong section base wall;
a conductive element spacer for maintaining said conductive element in a predetermined spaced apart relationship relative to said prong section base wall so that said conductive prong is positioned between said conductive element and said prong section base wall and electrically coupled to said conductive element when inserted into said prong receiving section.

28. The combination of claim 27 wherein said conductive element spacer includes a conductive element supporting section formed in said heating mat for supporting said conductive element in said predetermined spaced apart relationship relative to said prong section base wall.

29. The combination of claim 27 wherein said conductive element spacer is a filler component, said filler component at least partially filling said prong receiving section for supporting said conductive element in said predetermined spaced apart relationship relative to said prong section base wall, said filler component being deformable so as to allow passage of said conductive prong upon the latter being inserted into said prong receiving section.

30. The combination of claim 29 wherein said heating mat defines a mat longitudinal axis, said heating mat further comprising:
a generally planar electrically insulating sheet, said insulating sheet defining generally opposed first and second sheet surfaces extending adjacent said conductive element connecting section, said first sheet surface being oriented towards said resistive element;
said connecting recess being formed within said insulating sheet adjacent said conductive element connecting section and extending inwardly from said first sheet surface, said prong receiving section having generally opposed first and second prong section lateral walls extending between said first sheet surface and said prong section base wall;
wherein said first and second prong section lateral walls are sized to allow said prong receiving section to maintain said conductive element in said predetermined spaced apart relationship relative to said prong section base wall while being in electrically coupled to said prong when the latter is inserted into said prong receiving section.

31. The combination of claim 30 wherein said mat peripheral edge includes first and second generally opposed mat side edges and first and second longitudinal mat end edges extending therebetween, said mat connecting section including said first mat end edge.

32. The combination of claim 31 wherein said conductive element defines first and second generally opposed longitudinal conductive element ends, said first and second conductive element ends being adjacent said first and second mat end edges, respectively.

33. The combination of claim 32 wherein said conductive element is a first conductive element, said resistive element defining first and second resistive element side edges located adjacent said first and second mat side edges, respectively; said heating mat including a second conductive element extending between said first and second mat end edges, said first and second conductive elements being generally adjacent said first and second mat side edges and being electrically coupled to said first and second resistive element side edges, respectively;
wherein said conductive prong is a first conductive prong, said power bracket defining a second conductive prong being electrically connectable to another one of said electrical polarities, said first and second conductive prongs electrically coupling to said first and second conductive elements, respectively, upon insertion of said first and second conductive prongs into said prong receiving section of corresponding of said connecting recesses when said bracket connecting section is connected to said mat connecting section.

34. The combination of claim 33 wherein said bracket connecting section includes a mat receiving recess extending into said power bracket for receiving at least a section of said first mat end edge so that when said first mat end edge is inserted into said mat receiving recess with said mat connecting section connected to said bracket connecting section said first and second conductive prongs are inserted into said prong receiving section of corresponding of said connecting recesses and said first and second conductive prongs are electrically coupled to said first and second conductive elements, respectively.

35. The combination of claim 34 wherein said power bracket has a generally planar shape, said power bracket defining a bracket peripheral edge and generally opposed first and second bracket surfaces, said bracket connecting section extending along said bracket peripheral edge, said bracket connecting section including a bracket lid adjacent said mat receiving recess, said bracket lid being hingedly openable between an open configuration and a closed configuration, said bracket lid allowing insertion of said mat connecting section into said mat receiving recess when in said open configuration and securing said mat connecting section into said mat receiving recess with said first and second conductive prongs electrically coupled to said first and second conductive elements, respectively, when in said closed configuration.

36. The combination of claim 35 wherein said bracket connecting section includes a locking means for releasably locking said bracket lid into said closed configuration with said first and second conductive prongs electrically coupled to said first and second conductive elements, respectively, said locking means including a hook component mounted on said bracket lid for locking engagement with a complementary hook receiving component when said bracket lid is in said closed configuration.

37. The combination of claim 36 wherein said bracket connecting section includes a mat retaining means for retaining said mat connecting section connected to said bracket connecting section so that said heating mat is secured to said power bracket when said bracket lid is in said closed configuration with said mat connecting section connected to said bracket connecting section.

38. The combination of claim 37 wherein said electrically insulating sheet is a first electrically insulating sheet, said resistive element having a generally planar shape and defining first and second generally opposed resistive element surfaces, said heating mat further comprising:
a second generally planar electrically insulating sheet, said first sheet surface of each of said first and second insulating sheets being oriented towards a respective of said first and second resistive element surfaces;
said heating mat defining at least one through hole adjacent said mat connecting section, said through hole extending between second sheet surfaces of said first and second insulating sheets, said power bracket defining a protrusion stud adjacent said bracket connecting section, said protrusion stud extending outwardly from said power bracket into said mat receiving recess, said protrusion stud being located, configured and sized to fittingly engage said through hole when said mat connecting section is connected to said bracket connecting section, said protrusion stud and said through hole forming said mat retaining means when in fitting engagement with each other.

39. The combination of claim 38 wherein said resistive element includes a plurality of electrically resistive sub-elements being electrically connected in parallel relative to each other.

40. The combination of claim 39 wherein each of said resistive sub-elements defines first and second generally opposed sub-element ends, each of said sub-element ends being electrically connected to a respective of said first and second conductive elements, said plurality of resistive sub-elements being generally equally spaced apart from each other so as to define predetermined non-heat generating regions between adjacent of said resistive sub-elements.

41. The combination of claim 40 wherein said heating mat includes a plurality of apertures extending therethrough between said second sheet surfaces of said first and second insulating sheets, said apertures being located between adjacent of said resistive sub-elements;
at least one of said apertures being adjacent said mat connecting section, said power bracket defining an aperture stud adjacent said bracket connecting section, said protrusion stud extending outwardly from said power bracket into said mat receiving recess, said aperture stud being located, configured and sized to fittingly engage said at least one of said apertures when said mat connecting section is connected to said bracket connecting section, said aperture stud and said at least one of said apertures further forming said mat retaining means when in fitting engagement with each other.

42. The combination of claim 33 wherein said power bracket is generally elongated and defines generally opposed first and second bracket ends, said bracket connecting section generally extending between said first and second bracket ends,
said power bracket including a power cord, said power cord defining generally axially opposed first and second cord ends, said first cord end being electrically coupled to said first and second conductive prongs, said second cord end being electrically connectable to said power source.

43. The combination of claim 42 wherein said power bracket further includes a cord channel, said cord channel extending into said power bracket from one of said first and second bracket surfaces, said cord channel extending between said first and second bracket ends so that said power cord at least partially longitudinally engages said cord channel to extend from either one of said first and second bracket ends between said first and second bracket surfaces.

44. The combination of claim 33 further including a terminating bracket, said terminating bracket defining a terminating bracket peripheral edge and a mat receiving section adjacent said terminating bracket peripheral edge, said mat receiving section defining a mat receiving recess extending into said terminating bracket from said terminating bracket peripheral edge, said mat receiving recess being configured and sized to receive said second mat end edge therein so as to sealably secure said second mat end edge.

45. The combination of claim 44 wherein said terminating bracket has a generally planar shape, said terminating bracket defining generally opposed first and second terminating bracket surfaces, said mat receiving section extending along said terminating bracket peripheral edge, said mat receiving section including a bracket lid adjacent said mat receiving recess, said bracket lid being hingedly openable between an open configuration and a closed configuration, said bracket lid allowing insertion of said second mat end edge into said mat receiving recess when in said open configuration and securing said second mat end edge into said mat receiving recess when in said closed configuration.

46. The combination of claim 45 wherein said mat receiving section includes a locking means for releasably locking said bracket lid into said closed configuration with said second mat end edge is inserted into said mat receiving section, said locking means including a hook component mounted on said bracket lid for locking engagement with a complementary hook receiving component when said bracket lid is in said closed configuration.

47. The combination of claim 46 wherein said mat receiving section includes a mat retaining means for retaining said second mat end edge inserted into said mat receiving section so that said heating mat is secured to said terminating bracket when said bracket lid is in said closed configuration.

48. The combination of claim 47 wherein said electrically insulating sheet is a first electrically insulating sheet, said resistive element having a generally planar shape and defining first and second generally opposed resistive element surfaces, said heating mat further comprising:
a second generally planar electrically insulating sheet, said first sheet surface of each of said first and second insulating sheets being oriented towards a respective of said first and second resistive element surfaces;
said heating mat defining at least one through hole adjacent said second mat end edge, said through hole extending between second sheet surfaces of said first and second insulating sheets, said terminating bracket defining a protrusion stud adjacent said mat receiving section, said protrusion stud extending outwardly from said terminating bracket into said mat receiving recess, said protrusion stud being located, configured and sized to fittingly engage said through hole when said second mat end edge is connected to said mat receiving section, said protrusion stud and said through hole forming said mat retaining means when in fitting engagement with each other.

49. The combination of claim 33 wherein said first and second conductive elements have a generally elongated planar shape, each of said conductive elements defines first and second generally opposed conductive element surfaces, said first conductive element surfaces being oriented towards said first sheet surface, said second conductive element surfaces being oriented towards said resistive element.

50. The combination of claim 49 wherein said electrically insulating sheet is a first electrically insulating sheet, said resistive element having a generally planar shape and defining first and second generally opposed resistive element surfaces, said heating mat further comprising:
a second generally planar electrically insulating sheet, said first sheet surface of each of said first and second insulating sheets being oriented towards a respective of said first and second resistive element surfaces, at least one of said second sheet surface of at least one of said first and second insulating sheets insulating sheet having a textured pattern imprinted thereon.

51. The combination of claim 50 further including a third generally planar electrically insulating sheet and a generally planar electrically conductive sheet, said third insulating sheet and conductive sheet generally extending between said first and second mat end edges and substantially extending between said first and second mat side edges, said third insulating sheet and conductive sheet being positioned between said resistive element and said second insulating sheet with said third insulating sheet electrically isolating said resistive element from said conductive sheet.

52. The combination of claim 51 wherein said power source further defines a ground polarity, said power bracket defining a ground conductive prong extending towards said bracket connecting section, said ground conductive prong being electrically connectable to said ground polarity, said conductive sheet extending towards a ground connecting section located generally adjacent said mat first end edge;
a ground connecting recess extending into said second insulating sheet adjacent said ground connecting section, said ground connecting recess defining a ground prong receiving section for receiving at least a section of said ground conductive prong so that when said bracket connecting section is connected to said mat connecting section said ground conductive prong is inserted into said ground prong receiving section and said ground conductive prong is electrically coupled to said conductive sheet, said ground prong receiving section defining a ground prong section base wall;
a conductive sheet spacer for maintaining said conductive sheet in a predetermined spaced apart relationship relative to said ground prong section base wall so that said ground conductive prong is positioned between said conductive sheet and said ground prong section base wall and electrically coupled to said conductive sheet when inserted into said ground prong receiving section.

53. The combination of claim 37 wherein each of said first, second and third insulation sheets, said resistive element and said ground conductive sheet forms a heating mat layer, each of said layers being adhesively attached to adjacent of said layers.
